(19) United States
(12) Patent Application Publication
(10) Pub. No.: US 2024/0329000 A1
(43) Pub. Date: Oct. 3, 2024

(54) FLAW CLASSIFICATION DURING NON-DESTRUCTIVE TESTING

(71) Applicant: Evident Canada, Inc., Québec (CA)

(72) Inventor: Benoit Lepage, L'Ancienne-Lorette (CA)

(21) Appl. No.: 18/027,525

(22) PCT Filed: Sep. 20, 2021
(86) PCT No.: PCT/CA2021/051306

§ 371 Date: Mar. 21, 2023

Related U.S. Application Data
(60) Provisional application No. 63/086,753, filed on Oct. 2, 2020.

(51) Int. Cl. G01N 27/90; G01N 29/04; G01N 29/26; G06N 20/00

(52) U.S. Cl. CPC G01N 27/90; G01N 29/04; G01N 29/262; G06N 20/00; G01N 2291/023; G01N 2291/0289; G01N 2291/106

(57) ABSTRACT

Flaw detection information, acquired by one or more NDT modalities, can be applied to a trained machine learning model to automatically associate a detected flaw with a cluster of similar flaws. Then, a flaw identification output can be generated based on the association, such as indicted the flaw and an associated probability. In this manner, the described techniques can automatically classify and identify each detected flaw and, in some cases, no flaw conditions. These techniques can shorten the time between part rejection and flaw diagnosis and allow for automated process control.

### CLAIM OF PRIORITY

This application claims the benefit of priority of U.S. Provisional Patent Application Ser. No. 63/086,753, titled “FLAW CLASSIFICATION DURING NON-DESTRUCTIVE TESTING” to Benoit Lepage, filed on Oct. 2, 2020, the entire contents of which being incorporated herein by reference.

### FIELD OF THE DISCLOSURE

This document pertains generally, but not by way of limitation, to non-destructive evaluation using acoustic techniques.

### BACKGROUND

Various techniques can be used to perform inspection of structures in a non-destructive manner. Such techniques can include use of ionizing radiation such as X-rays for inspection, electromagnetic techniques such as eddy-current techniques, or acoustic techniques, as illustrative examples. In one approach, an ultrasonic transducer or an array of such transducers can be used to inspect a structure using acoustic energy. Ultrasonic inspection is useful for inspection of a variety of different structures including bar-shaped or tubular structures, welds, planar (e.g., plate materials), and composite materials such as carbon-fiber reinforced composite structures.

Inhomogeneities on or within the structure under test can generate scattered or reflected acoustic signals in response to a transmitted acoustic pulse. Such acoustic “echoes” can be received and processed. Such processing can include reconstruction of an image corresponding to a region of the structure under test, for review by an inspector or for archival. Features within the structure that can be detected and thereby imaged include interfaces between materials having different acoustic propagation characteristics, such as voids, cracks, or other flaws, and structures such as welds, joints, cladding layers, or surfaces.

### SUMMARY OF THE DISCLOSURE

The present inventor has recognized the desirability of automatically characterizing flaws during non-destructive testing (NDT) inspection. Automatically characterizing flaws can help a user, e.g., manufacturing plant manager, by providing early feedback on the production floor to improve quality control of one or more manufacturing lines.

Using various techniques of this disclosure, flaw detection information, acquired by one or more NDT modalities, can be applied to a trained machine learning model to automatically associate a detected flaw with a cluster of similar flaws. Then, a flaw identification output can be generated based on the association, such as indicted the flaw and an associated probability. In this manner, various techniques of this disclosure can automatically classify and identify each detected flaw and, in some cases, no flaw conditions. The techniques of this disclosure can shorten the time between part rejection and flaw diagnosis and allow for automated process control. For example, the techniques can allow live flaw characterization to be sent to the production mill, which automatically adapts production parameters.

In some aspects, this disclosure is directed to a computerized method of automatically identifying a flaw in a material during an inspection using a trained machine learning model, the method comprising: obtaining flaw detection information acquired at least in part by applying at least one non-destructive testing (NDT) modality to the material: applying the flaw detection information to the trained machine learning model to automatically associate the flaw with a cluster of similar flaws; and generating a flaw identification output based on the association.

In some aspects, this disclosure is directed to a computerized method of training processing circuitry using machine learning to identify a flaw in a material during an inspection, the method comprising: training a machine learning model to perform clustering on flaw detection information acquired at least in part by applying at least one non-destructive testing (NDT) modality to the material, wherein the clustering groups together similar flaws.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 illustrates generally an example of an acoustic inspection system that can be used to perform one or more techniques described in this disclosure.

FIG. 2 is a simplified schematic diagram of an example of an Eddy current system that can be used to perform one or more techniques described in this disclosure.

FIG. 3 is an example of a conceptual flow diagram showing an automatic identification of a flaw in a material during an inspection using a trained machine learning model, in accordance with various techniques of this disclosure.

FIG. 4 is an example of a flow diagram of a computerized method of automatically identifying a flaw in a material during an inspection using a trained machine learning model.

FIG. 5 shows an example machine learning module according to some examples of the present disclosure.

FIG. 6 illustrates a block diagram of an example machine upon which any one or more of the techniques (e.g., methodologies) discussed herein can perform.

### DETAILED DESCRIPTION

Non-destructive testing (NDT) can be used for inspection in a manufacturing environment to detect flaws in manufactured components, such as metal tubes or bars, or metal components. Non-destructive testing can be used to measure a quality level of the manufactured components as well as assist in diagnosing upstream problems in a manufacturing line.

Oftentimes, non-destructive testing is at or near the end of a manufacturing line. As such, there can be a long time between detecting a flaw in a manufactured component and modifying production processes in order to optimize the quality of the produced products.

In some examples, to train a machine learning model, a human user would need to manually tag all of the detected flaws. However, each manufacturer produces different flaws that depend on their particular manufacturing line. As such, building a generic trained machine learning model that works at all manufacturing locations can be difficult.

The present inventor has recognized the desirability of automatically characterizing flaws during NDT inspection. Automatically characterizing flaws can help a user, e.g., manufacturing plant manager, by providing early feedback on the production floor to improve quality control of one or more manufacturing lines.

Using various techniques of this disclosure and as described in more detail below, flaw detection information, acquired by one or more NDT modalities, can be applied to a trained machine learning model to automatically associate a detected flaw with a cluster of similar flaws. Then, a flaw identification output can be generated based on the association, such as indicted the flaw and an associated probability. In this manner, various techniques of this disclosure can automatically classify and identify each detected flaw and, in some cases, no flaw conditions. The techniques of this disclosure can shorten the time between part rejection and flaw diagnosis and allow for automated process control. For example, the techniques can allow live flaw characterization to be sent to the production mill, which automatically adapts production parameters.

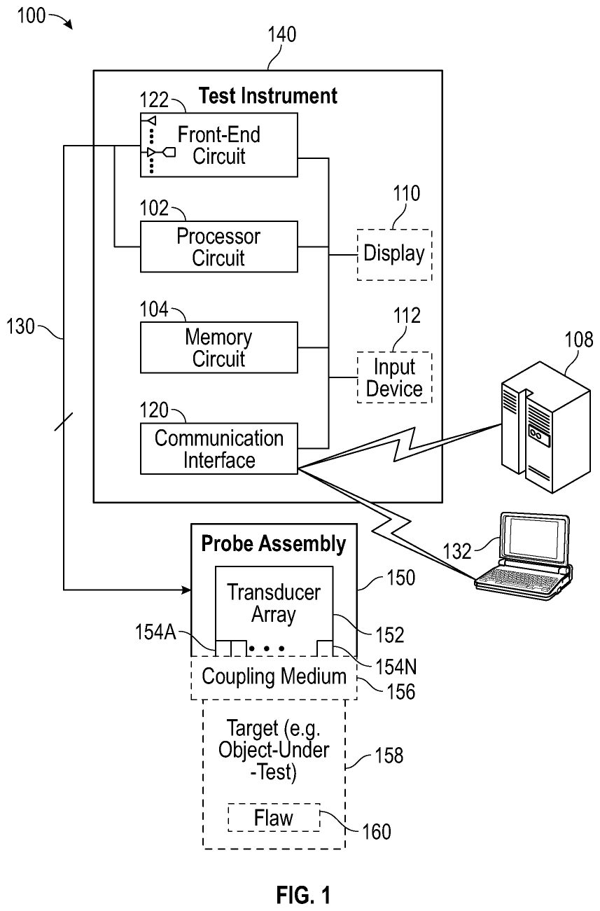

FIG. 1 illustrates generally an example comprising an acoustic inspection system 100 that can be used to perform one or more techniques described in this disclosure. The acoustic inspection system 100 of FIG. 1 is an example of an acoustic imaging modality, such as an acoustic phased array system, that can implement various techniques of this disclosure.

The inspection system 100 can include a test instrument 140, such as a hand-held or portable assembly. The test instrument 140 can be electrically coupled to a probe assembly, such as using a multi-conductor interconnect 130. The probe assembly 150 can include one or more electroacoustic transducers, such as a transducer array 152 including respective transducers 154A through 154N. The transducers array can follow a linear or curved contour or can include an array of elements extending in two axes, such as providing a matrix of transducer elements. The elements need not be square in footprint or arranged along a straight-line axis. Element size and pitch can be varied according to the inspection application.

A modular probe assembly 150 configuration can be used, such as to allow a test instrument 140 to be used with various different probe assemblies 150. Generally, the transducer array 152 includes piezoelectric transducers, such as can be acoustically coupled to a target 158 (e.g., an object under test) through a coupling medium 156. The coupling medium can include a fluid or gel or a solid membrane (e.g., an elastomer or other polymer material), or a combination of fluid, gel, or solid structures. For example, an acoustic transducer assembly can include a transducer array coupled to a wedge structure comprising a rigid thermoset polymer having known acoustic propagation characteristics (for example, Rexolite® available from C-Lec Plastics Inc.), and water can be injected between the wedge and the structure under test as a coupling medium 156 during testing.

The test instrument 140 can include digital and analog circuitry, such as a front-end circuit 122 including one or more transmit signal chains, receive signal chains, or switching circuitry (e.g., transmit/receive switching circuitry). The transmit signal chain can include amplifier and filter circuitry, such as to provide transmit pulses for delivery through an interconnect 130 to a probe assembly 150 for insonification of the target 158, such as to image or otherwise detect a flaw 160 on or within the target 158 structure by receiving scattered or reflected acoustic energy elicited in response to the insonification.

Although FIG. 1 shows a single probe assembly 150 and a single transducer array 152, other configurations can be used, such as multiple probe assemblies connected to a single test instrument 140, or multiple transducer arrays 152 used with a single or multiple probe assemblies 150 for tandem inspection. Similarly, a test protocol can be performed using coordination between multiple test instruments 140, such as in response to an overall test scheme established from a master test instrument 140, or established by another remote system such as a computing facility 108 or general purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receive signal chain of the front-end circuit 122 can include one or more filters or amplifier circuits, along with an analog-to-digital conversion facility, such as to digitize echo signals received using the probe assembly 150. Digitization can be performed coherently, such as to provide multiple channels of digitized data aligned or referenced to each other in time or phase. The front-end circuit 122 can be coupled to and controlled by one or more processor circuits, such as a processor circuit 102 included as a portion of the test instrument 140. The processor circuit 102 can be coupled to a memory circuit, such as to execute instructions that cause the test instrument 140 to perform one or more of acoustic transmission, acoustic acquisition, processing, or storage of data relating to an acoustic inspection, or to otherwise perform techniques as shown and described herein. The test instrument 140 can be communicatively coupled to other portions of the system 100, such as using a wired or wireless communication interface 120.

For example, performance of one or more techniques as shown and described herein can be accomplished on-board the test instrument 140 or using other processing or storage facilities such as using a computing facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system), such as in response to a request from the test instrument 140. Similarly, storage of imaging data or intermediate data such as A-line matrices of time-series data can be accomplished using remote facilities communicatively coupled to the test instrument 140. The test instrument can include a display 110, such as for presentation of configuration information or results, and an input device 112 such as including one or more of a key board, trackball, function keys or soft keys, mouse-interface, touch-screen, stylus, or the like, for receiving operator commands, configuration information, or responses to queries.

The acoustic inspection system 100 can acquire acoustic imaging data, such as FMC data, virtual source aperture (VSA) data, or phased array beam forming (PAUT) data, of a material using an acoustic imaging modality, such as an acoustic phased array system. The processor circuit 102 can then generate an acoustic imaging data set, such as a scattering matrix (S-matrix), plane wave matrix, or other matrix or data set, corresponding to an acoustic propagation mode, such as pulse echo direct (TT), self-tandem (TT-T), and/or pulse echo with skip (TT-TT). For PAUT, the processor circuit 102 can generate E-scan data, such as sectorial scan or linear scan), A-scan data, or C-scan data.

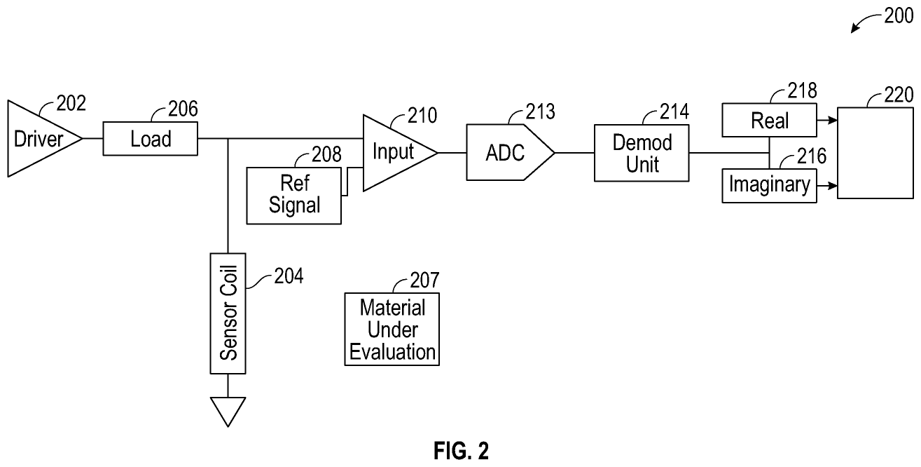

FIG. 2 is a simplified schematic diagram of an example of an Eddy current system that can be used to perform one or more techniques described in this disclosure. The system 200 can include a driver circuit 202 that can be responsive to an oscillatory signal generated by an oscillator. For example, the driver circuit 202 can form part of an Eddy current probe. The driver circuit 202 can include a sine/cosine wave generator to generate a sinusoidal wave, for example, at a chosen frequency. The driver circuit 202 can amplify the sinusoidal wave and excite a sensor coil 204 through a load 206, producing an alternating current and a magnetic field. When positioned near a material under evaluation 207, the magnetic field can induce an Eddy current in the material 207. The magnetic field can be affected by the material 207, such as by the conductivity and the permeability of the material.

Changes in metal hardness and conductivity, mechanical composition, heat treatment, and chemical treatment can interrupt or alter the amplitude, phase, and path of the Eddy current and the resulting magnetic field.

If a flaw in the material under evaluation 207 disturbs the Eddy current circulation, the magnetic coupling with the sensor coil 204 of the probe is changed and a defect signal be determined by measuring the coil impedance variation. For example, the sensor coil 204 and a reference voltage 208 can be coupled to an input of a differential amplifier 210.

The output of the differential amplifier 210 is a difference signal that represents the difference between the sensed signal from the sensor coil 204 and the reference voltage 208. The difference signal can be applied to an analog-to-digital converter (ADC) 213 that feeds a demodulator 214. The demodulator 214 can demodulate the harmonics of the difference signal into their resistive (real) and reactive (imaginary) components for analysis. The difference signal can be mixed (e.g., multiplied) by the demodulator 214 with the sine and cosine signals to generate the imaginary component 216 of the sensed signal and the real component 218 of the sensed signal based on the phase and amplitude changes of the sensor coil 204. The real components 218 and the imaginary components 216 of the harmonics of the signal can then be fed to the processor 220 and processed to determine whether any flaws are present in the material under evaluation 207.

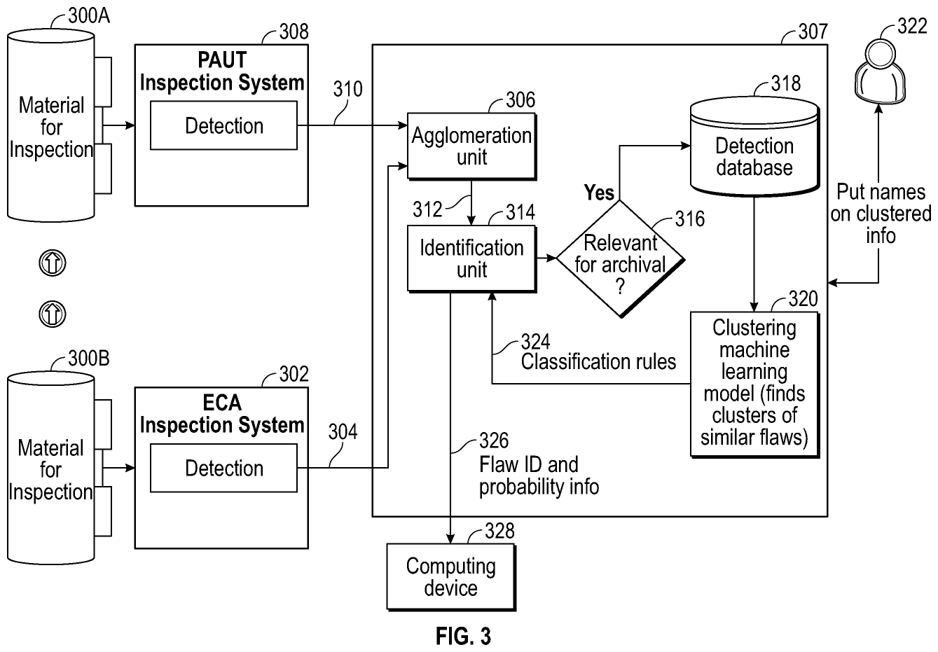

Using various techniques of this disclosure and as described in more detail below with respect to FIG. 3, flaw detection information, acquired by one or more NDT modalities, such as the NDT inspection systems 100, 200 of FIGS. 1 and 2, respectively, can be applied to a trained machine learning model to automatically associate a flaw with a cluster of similar flaws. Then, a flaw identification output can be generated based on the association. In this manner, various techniques of this disclosure can automatically classify and identify each detected flaw and, in some cases, no flaw conditions.

FIG. 3 is an example of a conceptual flow diagram showing an automatic identification of a flaw in a material during an inspection using a trained machine learning model, in accordance with various techniques of this disclosure. As seen in FIG. 3, material to be inspected, such as materials 300A, 300B, moves through a manufacturing line. Examples of flaws can include porosity issues, slag, surface scratches, and cracks.

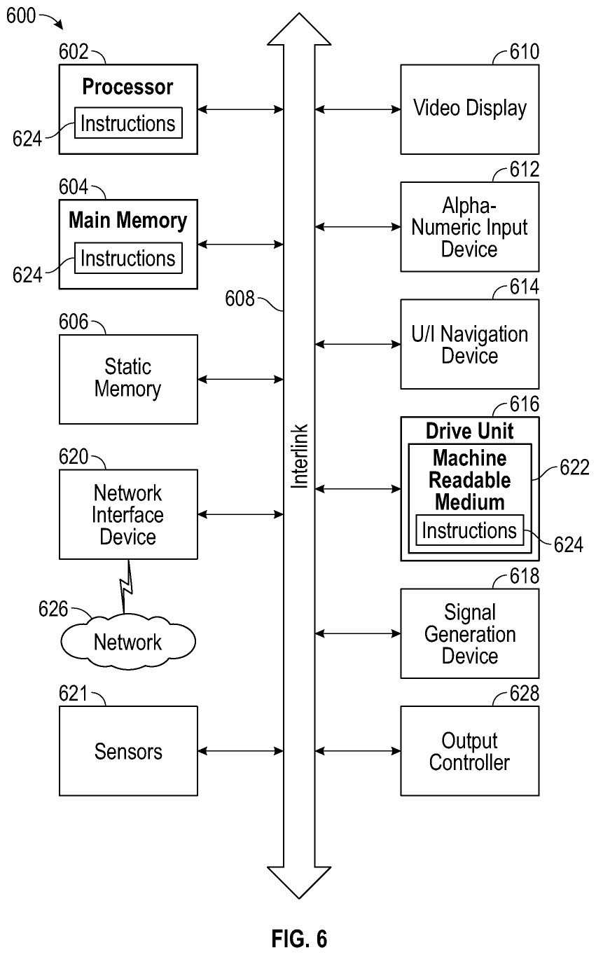

The techniques shown and described in this document can be performed using a portion or an entirety of one or more NDT inspection systems, such as but not limited to the inspection systems 100, 200 as shown in FIGS. 1 and 2, and/or using a machine 600 as discussed below in relation to FIG. 6.

In the non-limiting example shown, the material 300A can first be tested using a first non-destructive testing (NDT) modality, such as an Eddy current array (ECA) inspection system 302. The ECA inspection system 302 can be similar to the Eddy current system 200 of FIG. 2. Although FIG. 2 illustrates a signal channel Eddy current system, it should be understood that multi-channel systems can be used to implement various techniques of this disclosure. The ECA inspection system 302 can detect whether one or more flaws are present in the material 300A (or whether no flaws are present in the material 300A), and output flaw detection information 304 to a position-based detection agglomeration unit 306 in a flaw clustering engine 307. In some example, the flaw detection information 304 can be amplitude based. The ECA inspection system 302 can detect surface flaws in the material 300A.

Then, the material 300A moves through the manufacturing line and can be tested using a second non-destructive testing (NDT) modality, such as using a phased-array ultrasonic testing (PAUT) inspection system 308. The PAUT inspection system 308 can be similar to the acoustic inspection system 100 of FIG. 1. The PAUT inspection system 308 can detect areas of interest in the signal using detection methods such as thresholding. Then, the PAUT inspection system can determine whether one or more flaws are present in the material 300A (or whether no flaws are present in the material 300A), and output flaw detection information 310 to the position-based detection agglomeration unit 306, where agglomeration can be based on the position of the indication. For example, the position-based agglomeration unit 306 can agglomerate as one flaw each indication located at less than 50 mm from each other.

In some systems, a signal having an amplitude above the amplitude threshold is considered a flaw. The techniques of this disclosure can advantageously enable selective sorting of rejectable conditions based not only on the signal amplitude but also on the signal patterns.

In some examples, the flaw detection information 310 can be amplitude-based. The PAUT inspection system 308 can detect internal flaws in the material 300A.

In some examples, the flaw detection information 310 of the PAUT inspection system 308 can include S-matrix data. In other examples, the flaw detection information 310 can include A-scan data or C-scan data.

Although two NDT inspection systems are shown in the non-limiting example shown in FIG. 3, namely ECA inspection system 302 and the PAUT inspection system 308, other implementations can include a single NDT inspection system. In other examples, other NDT inspection systems, such as a visual inspection system and/or an X-ray inspection system, can be used in addition to or instead of one or both of the ECA or PAUT inspection systems. In some examples, more than two NDT inspection systems can be used together.

The agglomeration unit 306 can receive the detection signals that include the flaw detection information 304, 310 from either or both of the ECA inspection system 302 and the PAUT inspection system 308 and merge together some or all of the data associated with a particular flaw based on the position of the flaw in the material. For example, the flaw detection information 304 from the ECA inspection system 302 can indicate that there is a first area of interest in the material 300A, e.g., between 100 mm and 200 mm on the surface of a metal bar. Then, the flaw detection information 310 from the PAUT inspection system 308 can indicate that there is a second area of interest in the material 300A, e.g., between 300 mm and 350 mm and at a depth of 100 mm from the surface of the metal bar. The agglomeration unit 306 can merge the information from the detections signals that include the flaw detection information 304, 310 together and determine that in this non-limiting example, the first and second areas of interest are two different flaws because of their spatial relationship to one another.

As another example, the flaw detection information 304 from the ECA inspection system 302 can indicate that there is a first area of interest in the material 300A, e.g., between 100 mm and 200 mm on the surface of a metal bar. Then, the flaw detection information 310 from the PAUT inspection system 308 can indicate that there is a second area of interest in the material 300A, e.g., between 100 mm and 200 mm and extending from the surface to a depth of 100 mm in the metal bar. The agglomeration unit 306 can merge the information from the detections signals that include the flaw detection information 304, 310 and determine that in this non-limiting example, the first and second areas of interest are likely the same flaw because of their spatial relationship to one another.

In some examples, the agglomeration unit 306 can determine a distance between two areas of interest and compare that distance to a threshold. If the distance is below the threshold, the agglomeration unit 306 can determine that the two areas of interest are the same flaw, and if the distance is above the threshold, the agglomeration unit 306 can determine that the two areas of interest are different flaws. The agglomeration unit 306 can output data 312 to an identification unit 314. The data 312 can include information for each flaw to be identified, such as a product number associated with the material 300A and the determined location of the flaw in the material.

The identification unit 314 can receive the data 312 from the agglomeration unit 314. The identification unit 314 can attempt to identify the flaw(s) detected or no flaw detected, as described in more detail below. In addition, the identification unit 314 can determine, at block 316, whether the data 312 is relevant for archival or storage in a database 318.

For example, initially, when the database 318 has little flaw information stored, the identification unit 314 can determine that most or all the data 312 is relevant for archival or storage in the database 318. However, the identification unit 314 can include conditions for archival or storage. For example, as the identification unit's confidence in a detected flaw or detected no flaw condition improves, less data can be archived or stored. As an example, if the identification unit 314 determines that there is at least a 99% probability that no flaw is present in the material 300A, then the identification unit 314 does not archive or store the data 312 to the database 318. As such, a confidence threshold can be used for storage. Otherwise, the data 312 can be stored in the database 318.

In other examples, the identification unit 314 can archive data only for flaws that are not well classified. For example, if the identification unit 314 determines that the probability is above a threshold that a flaw in the material 300A is classified as a particular type of flaw, such as crack, then the identification unit 314 does not archive the data 312 to the database 318. Otherwise, the data 312 can be stored in the database 318. In this manner, the database 318 can store data of flaws in the material being detected, and data of no flaws being detected, to generate a sufficiently large collection to identify clusters of detections that are similar, such as clusters of cracks, porosity issues, slag, surface scratches, and even no flaw conditions.

Using the data 312 stored in the database 318, a machine, such as shown in FIG. 600, can perform a dimensionality reduction technique, such as principal component analysis (PCA), to cluster similar flaws together. In some examples, a user, e.g., a metallurgist, can then tag the clusters by assigning names to similar flaws. As an example, to help tag the cluster, the user can cut a metallic bar and perform a metallographic analysis. In some examples, the same flaw, such as porosity, can cause different flaw clusters, such as issues with the surface of a material and issues not on the surface.

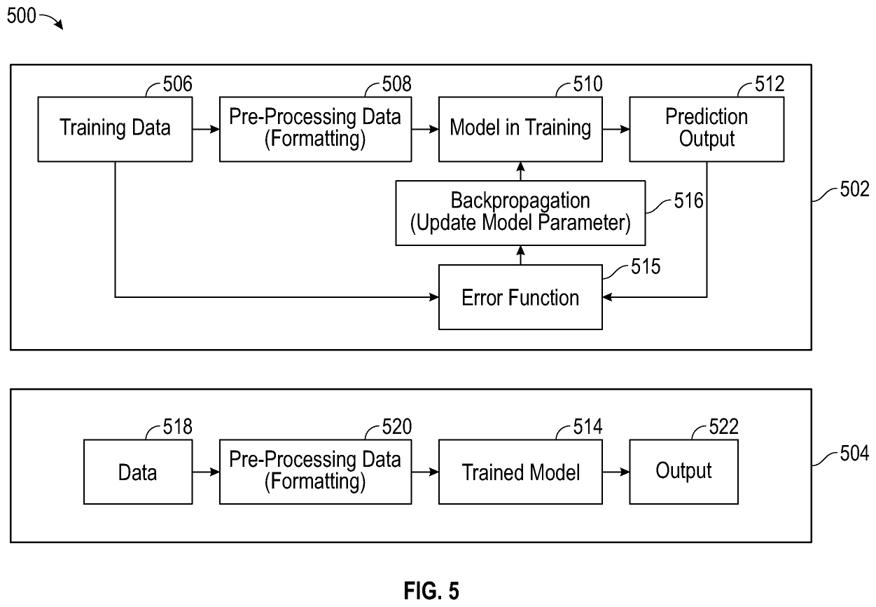

To train a clustering machine learning model 320, the user 322 can tag the clusters and apply the tagged clusters to the clustering machine learning model 320, as described in more detail below with respect to FIG. 5. Once trained, the clustering machine learning model 320 can receive flaw detection information from one or more inspection systems, such as the one or both of the systems 100, 200 or other NDT inspection systems, and automatically associate the flaw (or no flaw) with a cluster of similar flaws (or no flaws).

For example, the agglomeration unit 306 can obtain flaw detection information associated with a material, such as the material 300A of FIG. 3, from at least one NDT inspection system, such as the ECA inspection system 100 of FIG. 1 and/or the PAUT inspection system 200 of FIG. 2. The flaw detection information can then be applied to the previously trained clustering machine learning model 320. The previously trained clustering machine learning model 320 formed by the dimensionality reduction techniques, such as PCA, and the tags associated with the model can represent classification rules 324 that can be applied to the identification unit 314. Using the classification rules 324, the identification unit 314 can automatically associate the flaw with a cluster of similar flaws. As an example, the identification unit 314 can automatically associate the flaw with a cluster that was tagged as including cracks.

Then, the identification unit 314 can generate a flaw identification output 326 based on the association. For example, the flaw identification output 326 can include a flaw identification, e.g., crack, porosity, not a flaw or reject, etc., and a probability associated with the flaw identification, such as a 90% probability that the flaw is a crack. The flaw identification output 326 can be transmitted to a computing device 328, such as a computer of the production plant.

The flaw clustering engine 307 can be a computer program. One or more of the agglomeration unit 306, the identification unit 314, the database 318, and the clustering machine learning model 320 and any algorithms described in this disclosure can be implemented using the machine 600 of FIG. 6. For example, one or more of the agglomeration unit 306, the identification unit 314, the database 318, and the clustering machine learning model 320 can be implemented using instructions 624 that are executed by the processor 602. The flaw clustering engine 307 and the machine learning model 320 can be co-located on one machine or located in different machines.

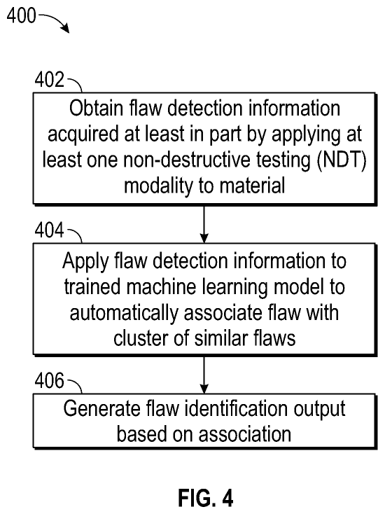

FIG. 4 is an example of a flow diagram of a computerized method 400 of automatically identifying a flaw in a material during an inspection using a trained machine learning model. At block 402, the method 400 can include obtaining flaw detection information acquired at least in part by applying at least one non-destructive testing (NDT) modality to the material. For example, the agglomeration unit 306 can obtain flaw detection information associated with a material, such as the material 300A of FIG. 3, from at least one NDT inspection system, such as the ECA inspection system 100 of FIG. 1 and/or the PAUT inspection system 200 of FIG. 2.

At block 404, the method 400 can include applying the flaw detection information to the trained machine learning model to automatically associate the flaw with a cluster of similar flaws. For example, the flaw detection information can then be applied to the previously trained clustering machine learning model 320 of FIG. 3. The previously trained clustering machine learning model 320 formed by the dimensionality reduction techniques, such as PCA, and the tags associated with the model can represent classification rules that can be applied to the identification unit 314.

At block 406, the method 400 can include generating a flaw identification output based on the association. For example, using the classification rules, the identification unit 314 of FIG. 3 can automatically associate the flaw with a cluster of similar flaws. As an example, the identification unit 314 can automatically associate the flaw with a cluster that was tagged as including cracks.

FIG. 5 shows an example machine learning module 500 according to some examples of the present disclosure. The machine learning module 500 can be implemented in whole or in part by one or more computing devices. In some examples, a training module 502 can be implemented by a different device than a prediction module 504. In these examples, the trained model 514 can be created on a first machine and then sent to a second machine.

The machine learning module 500 utilizes a training module 502 and a prediction module 504. The training module 502 can implement a computerized method of training processing circuitry, such as the processor 602 of FIG. 6, using machine learning to identify a flaw in a material during an NDT inspection. The training module 502 can be trained to neatly cluster similar flaws together by performing a dimensionality reduction technique, such as principal component analysis (PCA). Then, a user, e.g., a metallurgist, can tag the clusters by assigning names to similar flaws. As an example, to help tag the cluster, the user can cut a metallic bar and perform a metallographic analysis.

In some examples, the same flaw, such as porosity, can cause different flaw clusters, such as issues with the surface of a material and issues not on the surface. In some examples, to simplify the process, the number of clusters can be a user input. Alternatively, the system can automatically test its ability to form clean cluster and learn the appropriate number of clusters. The training module 502 can pre-process the training data 506, e.g., encode the training data 506, using a pre-processing module 508.

The training data 506 can include, for example, tags of clusters of flaws, as applied by a user to the clusters, such as the user 322 in FIG. 3. Using this training data, the machine learning model in training 510 can be trained to identify a type of flaw in a material and associate a probability with the type of flaw.

During training, the training module 502 can compare the training data 506 and the prediction output 512 and generate an error function 515 based on the comparison. In some examples, the training module 502 can update the model in training 512 in response to the error function 515, such as by using backpropagation module 516.

In the prediction module 504, the data 518 can be input and pre-processed, e.g., encoded, using a pre-processing module 520. The data 518 can include data from the NDT modalities, including ECA data, PAUT data, X-ray data, and/or visual inspection data. The pre-processing module 520 generates a formatted data, which is input into the trained model 514 to generate a flaw identification output, resulting in an output 522.

The machine learning model in training 512 can be selected from among many different potential supervised or unsupervised machine learning algorithms. Examples of learning algorithms include artificial neural networks, convolutional neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, logistic regression, a region based CNN, a full CNN (for semantic segmentation), a mask R-CNN algorithm for instance segmentation, and hidden Markov models. Examples of unsupervised learning algorithms include expectation-maximization algorithms, vector quantization, and information bottleneck method.

In this manner, the machine learning module 500 of FIG. 5 can assist in implementing a computerized method of image processing using processing circuitry to apply a previously trained machine learning model in a system for non-destructive testing (NDT) of a material, in accordance with this disclosure.

The techniques shown and described in this document can be performed using a portion or an entirety of one or more NDT inspection systems, such as NDT inspection systems 100, 200 shown in FIGS. 1 and 200, respectively, and otherwise using a machine 600 as discussed below in relation to FIG. 6.

FIG. 6 illustrates a block diagram of an example of a machine upon which any one or more of the techniques (e.g., methodologies) discussed herein can perform. In alternative embodiments, the machine 600 can operate as a standalone device or are connected (e.g., networked) to other machines. In a networked deployment, the machine 600 can operate in the capacity of a server machine, a client machine, or both in server-client network environments. In an example, the machine 600 can act as a peer machine in peer-to-peer (P2P) (or other distributed) network environment. The machine 600 is a personal computer (PC), a tablet PC, a set-top box (STB), a personal digital assistant (PDA), a mobile telephone, a smart phone, a web appliance, a network router, switch or bridge, a server computer, a database, conference room equipment, or any machine capable of executing instructions (sequential or otherwise) that specify actions to be taken by that machine. In various embodiments, machine 600 can perform one or more of the processes described above. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Examples, as described herein, can include, or can operate on, logic or a number of components, modules, or mechanisms (all referred to hereinafter as “modules”). Modules are tangible entities (e.g., hardware) capable of performing specified operations and is configured or arranged in a certain manner. In an example, circuits are arranged (e.g., internally or with respect to external entities such as other circuits) in a specified manner as a module. In an example, the whole or part of one or more computer systems (e.g., a standalone, client or server computer system) or one or more hardware processors are configured by firmware or software (e.g., instructions, an application portion, or an application) as a module that operates to perform specified operations. In an example, the software can reside on a non-transitory computer readable storage medium or other machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor is configured as respective different modules at different times. Software can accordingly configure a hardware processor, for example, to constitute a particular module at one instance of time and to constitute a different module at a different instance of time.

Machine (e.g., computer system) 600 can include a hardware processor 602 (e.g., a central processing unit (CPU), a graphics processing unit (GPU), a hardware processor core, or any combination thereof), a main memory 604, and a static memory 606, some or all of which can communicate with each other via an interlink 608 (e.g., bus). The machine 600 can further include a display unit 610, an alphanumeric input device 612 (e.g., a keyboard), and a user interface (UI) navigation device 614 (e.g., a mouse). In an example, the display unit 610, input device 612 and UI navigation device 614 are a touch screen display. The machine 600 can additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 can include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 can include a machine readable medium 622 on which is stored one or more sets of data structures or instructions 624 (e.g., software) embodying or utilized by any one or more of the techniques or functions described herein. The instructions 624 can also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 can constitute machine readable media.

While the machine readable medium 622 is illustrated as a single medium, the term “machine readable medium” can include a single medium or multiple media (e.g., a centralized or distributed database, and/or associated caches and servers) configured to store the one or more instructions 624.

The term “machine readable medium” can include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples can include solid-state memories, and optical and magnetic media. Specific examples of machine readable media can include: non-volatile memory, such as semiconductor memory devices (e.g., Electrically Programmable Read-Only Memory (EPROM), Electrically Erasable Programmable Read-Only Memory (EEPROM)) and flash memory devices: magnetic disks, such as internal hard disks and removable disks: magneto-optical disks: Random Access Memory (RAM): Solid State Drives (SSD); and CD-ROM and DVD-ROM disks. In some examples, machine readable media can include non-transitory machine-readable media. In some examples, machine readable media can include machine readable media that is not a transitory propagating signal.

The instructions 624 can further be transmitted or received over a communications network 626 using a transmission medium via the network interface device 620. The machine 600 can communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 602.11 family of standards known as Wi-Fi®, IEEE 602.16 family of standards known as WiMax®), IEEE 602.15.4 family of standards, a Long Term Evolution (LTE) family of standards, a Universal Mobile Telecommunications System (UMTS) family of standards, peer-to-peer (P2P) networks, among others. In an example, the network interface device 620 can include one or more physical jacks (e.g., Ethernet, coaxial, or phone jacks) or one or more antennas to connect to the communications network 626. In an example, the network interface device 620 can include a plurality of antennas to wirelessly communicate using at least one of single-input multiple-output (SIMO), multiple-input multiple-output (MIMO), or multiple-input single-output (MISO) techniques. In some examples, the network interface device 620 can wirelessly communicate using Multiple User MIMO techniques.

Examples, as described herein, can include, or can operate on, logic or a number of components, modules, or mechanisms. Modules are tangible entities (e.g., hardware) capable of performing specified operations and are configured or arranged in a certain manner. In an example, circuits are arranged (e.g., internally or with respect to external entities such as other circuits) in a specified manner as a module. In an example, the whole or part of one or more computer systems (e.g., a standalone, client, or server computer system) or one or more hardware processors are configured by firmware or software (e.g., instructions, an application portion, or an application) as a module that operates to perform specified operations. In an example, the software can reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor is configured as respective different modules at different times. Software can accordingly configure a hardware processor, for example, to constitute a particular module at one instance of time and to constitute a different module at a different instance of time.

Various embodiments are implemented fully or partially in software and/or firmware. This software and/or firmware can take the form of instructions contained in or on a non-transitory computer-readable storage medium. Those instructions can then be read and executed by one or more processors to enable performance of the operations described herein. The instructions are in any suitable form, such as but not limited to source code, compiled code, interpreted code, executable code, static code, dynamic code, and the like. Such a computer-readable medium can include any tangible non-transitory medium for storing information in a form readable by one or more computers, such as but not limited to read only memory (ROM): random access memory (RAM); magnetic disk storage media: optical storage media: flash memory; etc.

### Various Notes

Each of the non-limiting aspects or examples described herein can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code can form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact discs and digital video discs), magnetic cassettes, memory cards or sticks, random access memories (RAMs), read only memories (ROMs), and the like.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A computerized method of automatically identifying a flaw in a material during an inspection using a trained machine learning model, the method comprising:
obtaining flaw detection information acquired at least in part by applying at least one non-destructive testing (NDT) modality to the material;
applying the flaw detection information to the trained machine learning model to automatically associate the flaw with a cluster of similar flaws; and
generating a flaw identification output based on the association.

2. The computerized method of claim 1, wherein the at least one NDT modality includes Eddy current testing.

3. The computerized method of claim 1, wherein the at least one NDT modality includes phased array ultrasonic testing.

4. The computerized method of claim 1, wherein the at least one NDT modality includes Eddy current testing and phased array ultrasonic testing.

5. The computerized method of claim 1, wherein the flaw identification output includes a type of flaw.

6. The computerized method of claim 5, wherein the type of flaw includes at least one of a crack, a porosity, or no flaw.

7. The computerized method of claim 5, wherein the flaw identification output includes a probability of the identified flaw.

8. The computerized method of claim 1, comprising:
storing data related to the flaw detection information in a database.

9. The computerized method of claim 8, wherein storing data related to the flaw detection information in a database includes:
storing data related to the flaw detection information in the database when a condition is satisfied.

10. A computerized method of training processing circuitry using machine learning to identify a flaw in a material during an inspection, the method comprising:
training a machine learning model to perform clustering on flaw detection information acquired at least in part by applying at least one non-destructive testing (NDT) modality to the material, wherein the clustering groups together similar flaws.

11. The computerized method of claim 10, wherein the at least one NDT modality includes Eddy current testing.

12. The computerized method of claim 10, wherein the at least one NDT modality includes phased array ultrasonic testing.

13. The computerized method of claim 10, wherein the at least one NDT modality includes Eddy current testing and phased array ultrasonic testing.

14. The computerized method of claim 10, wherein the training includes:
performing a dimensionality reduction technique to cluster similar flaws together.

15. The computerized method of claim 10, wherein the training includes:
receiving a tag and association the tag with a corresponding cluster of flaws.
